(19) United States
(12) Patent Application Publication
(10) Pub. No.: US 2026/0088475 A1
(43) Pub. Date: Mar. 26, 2026

(54) BATTERY CELL AND METHOD OF MANUFACTURING BATTERY CELL

(71) Applicant: SK On Co., Ltd., Seoul (KR)

(72) Inventors: Dong Hyee LEE, Daejeon (KR); Seung Hoon JU, Daejeon (KR)

(21) Appl. No.: 19/319,722

(22) Filed: Sep. 5, 2025

(30) Foreign Application Priority Data
Sep. 26, 2024 (KR) 10-2024-0130922

(51) Int. Cl. H01M 50/627; H01M 10/04; H01M 50/559

(52) U.S. Cl. CPC H01M 50/627; H01M 10/049; H01M 50/559

(57) ABSTRACT

A method of manufacturing a battery cell includes preparing a case including a lower plate, disposing an insulator on the lower plate of the case using a first adhesive member, disposing an electrode assembly on the insulator, and injecting an electrolyte into the case. The adhesive member may be melted by the electrolyte.

### CROSS-REFERENCE TO RELATED APPLICATION(S)

This patent document claims the priority and benefits of Korean Patent Application No. 10-2024-0130922 filed on Sep. 26, 2024, the disclosure of which is incorporated herein by reference in its entirety.

### TECHNICAL FIELD

The disclosure and implementations disclosed in this patent document generally relate to a battery cell and a method of manufacturing a battery cell.

### BACKGROUND

Unlike primary batteries, secondary batteries may be recharged and discharged, and thus be applied to various fields, such as digital cameras, mobile phones, laptops, hybrid and electric vehicles, and energy storage systems (ESS). Secondary batteries may be lithium-ion batteries, nickel-cadmium batteries, nickel-metal hydride batteries, or nickel-hydrogen batteries.

### SUMMARY

The present disclosure can be implemented in some embodiments to provide a battery cell including an electrode assembly, a case (for example, a can), and an insulator. The insulator may be assembled by being seated on the bottom of the case. However, if the insulator is seated on the bottom of the case, the position of the insulator and electrode assembly may not be regulated, which may reduce the structural stability of the battery cell. Furthermore, if the insulator is seated on the bottom of the case, a separate process is required to regulate the insulator's position, which may increase the cost of the battery cell manufacturing process. To regulate the insulator's position, the insulator may be assembled by being bonded to the bottom of the case. However, the adhesive inside the case may chemically react with the electrolyte. This chemical reaction between the adhesive and the electrolyte may impede current flow and reduce the performance of the battery cell.

According to an aspect of the present disclosure, a method of manufacturing a battery cell with reduced manufacturing costs and a battery cell manufactured thereby may be provided.

According to an aspect of the present disclosure, a method of manufacturing a battery cell with a reduced manufacturing defect rate and a battery cell manufactured thereby may be provided.

The battery cell and method of manufacturing a battery cell in the present disclosure may be widely applied to devices within green technology fields such as electric vehicles, battery charging stations, and other battery-based solar and wind power generation devices. Furthermore, the cell and method of manufacturing a battery cell of the present disclosure may be used in eco-friendly electric vehicles, hybrid vehicles, and the like, which aim to prevent climate change by reducing air pollution and greenhouse gas emissions.

In some embodiments of the present disclosure, a method of manufacturing a battery cell includes preparing a case including a lower plate, disposing an insulator on the lower plate of the case using a first adhesive member, disposing an electrode assembly on the insulator, and injecting an electrolyte into the case. The adhesive member is configured to be liquefied by the electrolyte.

In an embodiment, the first adhesive member may include at least one of polyethylene terephthalate, epoxy, polyethylene, polyimide, polyvinyl chloride, polyacrylonitrile, or polycarbonate.

In an embodiment, the method of manufacturing a battery cell may further include disposing the first adhesive member by applying the first adhesive member to the lower plate.

In an embodiment, te first adhesive member may be in contact with the case while being adhered to the insulator.

In an embodiment, the first adhesive member may be an adhesive tape, an adhesive, or a coating agent.

In an embodiment, the disposing the electrode assembly may be performed by attaching the electrode assembly to the insulator using a second adhesive member. The second adhesive member may be configured to be melted by the electrolyte.

In an embodiment, the second adhesive member may be in contact with the electrode assembly while being adhered to the insulator.

In some embodiments of the present disclosure, a battery cell includes an electrode assembly, a case including a lower plate supporting the electrode assembly, an insulator at least partially positioned between the electrode assembly and the lower plate, and an adhesive member melted by an electrolyte and mixed with the electrolyte after the insulator is secured to the lower plate.

In an embodiment, the adhesive member may include at least one of polyethylene terephthalate, epoxy, polyethylene, polyimide, polyvinyl chloride, polyacrylonitrile, or polycarbonate.

In an embodiment, the battery cell may further include a current collector plate bonded to an uncoated portion of the electrode assembly, and a terminal portion in contact with the current collector plate and coupled to the lower plate.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIG. 2 is a flowchart of a method of manufacturing a battery cell according to an embodiment.

FIG. 3 is a schematic diagram illustrating the assembly of a battery cell including a first adhesive member according to an embodiment.

FIG. 4 is a schematic diagram illustrating the assembly of a battery cell including a first adhesive member and a second adhesive member according to an embodiment.

FIG. 5 is a cross-sectional view of a battery cell with a molten adhesive member according to an embodiment.

### DETAILED DESCRIPTION

Features of the present disclosure disclosed in this patent document are described by example embodiments with reference to the accompanying drawings.

Hereinafter, the present disclosure will be described in detail with reference to the attached drawings. However, these are merely illustrative and the present disclosure is not limited to the detailed embodiments illustrated herein.

Terms and words used in this specification and claims described below are not to be construed as limited to their conventional or dictionary meanings. Based on the principle that the inventor may appropriately define the concepts of terms to best describe his or her invention, the meaning and concepts will be interpreted in accordance with the technical spirit of the present disclosure.

Therefore, the embodiments described in this specification and the configurations depicted in the drawings represent only the appropriate embodiments of the present disclosure and do not represent the entire technical spirit of the present disclosure. It should be understood that various equivalents and modifications may exist as of the time of filing.

Detailed descriptions of well-known functions and configurations that may obscure the gist of the present disclosure are omitted. In the attached drawings, some components are exaggerated, omitted, or schematically illustrated, and the dimensions of respective components do not fully reflect the actual size.

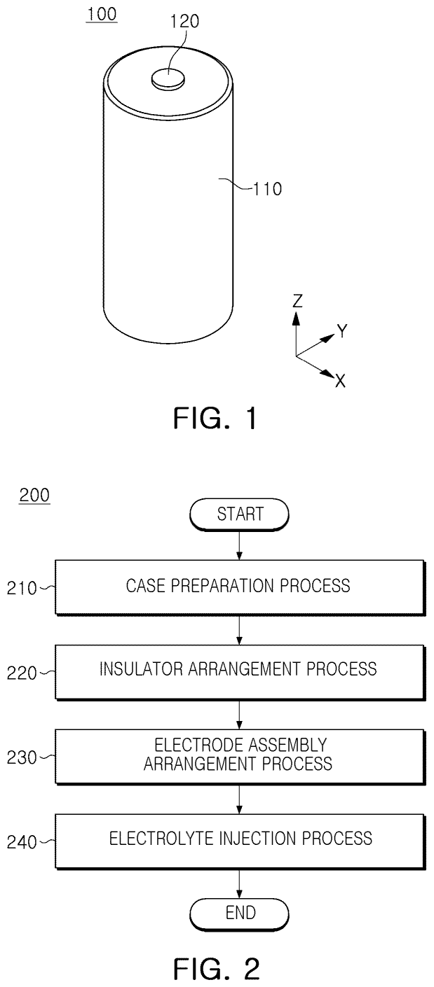

FIG. 1 is a perspective view of a battery cell according to an embodiment.

Referring to FIG. 1, a battery cell 100 may include a case 110 and a terminal portion 120.

The battery cell 100 may be a secondary battery. For example, the battery cell 100 may be a lithium ion battery, but is not limited thereto. For example, the battery cell 100 may be a nickel-cadmium battery, a nickel-metal hydride battery, or a nickel-hydrogen battery capable of being charged and discharged.

The case 110 may form at least a portion of the appearance of the battery cell 100.

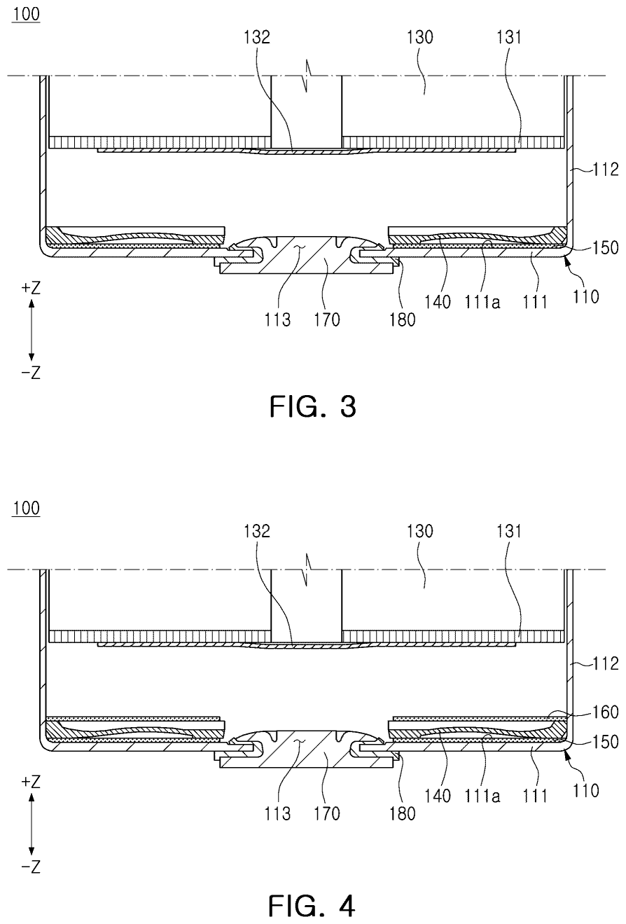

The case 110 may provide an internal space that accommodates components of the battery cell 100 (for example, an electrode assembly 130 and electrolyte of FIG. 3). The case 110 may have a substantially cylindrical exterior. In an embodiment, the case 110 may be referred to as a can.

The terminal portion 120 may provide a path for transmitting current to the outside of the battery cell 100. The terminal portion 120 may be electrically connected to the electrode assembly 130.

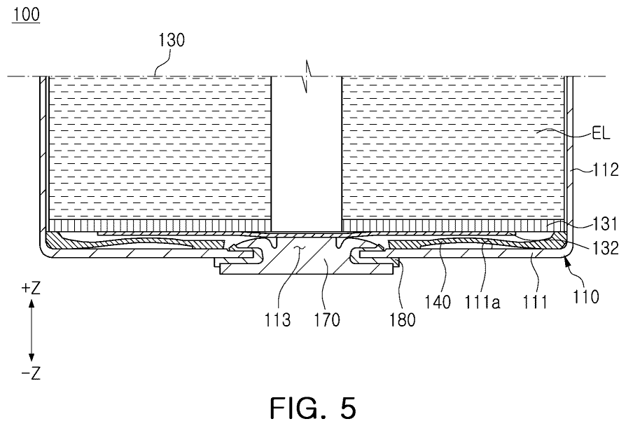

FIG. 2 is a flowchart illustrating a method of manufacturing a battery cell, according to an embodiment. FIG. 3 is a schematic diagram illustrating the assembly of a battery cell including a first adhesive member, according to an embodiment. FIG. 4 is a schematic diagram illustrating the assembly of a battery cell including a first adhesive member and a second adhesive member, according to an embodiment. FIG. 5 is a cross-sectional view of a battery cell with the adhesive member in a molten state, according to an embodiment.

Referring to FIGS. 3 to 5, along with FIG. 1, the battery cell 100 may include a case 110, an electrode assembly 130, and/or an insulator 140. The description of the battery cell 100 of FIG. 1 may be applied to the battery cell 100 of FIGS. 3 to 5.

The case 110 may include a lower plate 111. The lower plate 111 may support the electrode assembly 130. The lower plate 111 may accommodate the terminal portion 170.

The case 110 may include a wall portion 112 extending from the lower plate 111.

The electrode assembly 130 may include a cathode plate, an anode plate, and a separator. The separator may prevent contact between the cathode plate and the anode plate. Those skilled in the art will appreciate that the electrode assembly 130 may be manufactured using various methods. According to example embodiments, an electrode assembly may be formed by repeatedly disposing a cathode, an anode, and a separator. In some embodiments, the electrode assembly may be a winding type, a stacking type, a z-folding type, or a stack-folding type.

In an embodiment, the battery cell 100 may be a tabless battery cell. For example, the battery cell 100 may include a current collector plate 132 bonded to an uncoated portion 131 of the electrode assembly 130. The electrode assembly 130 may be electrically connected to the current collector plate 132 using the uncoated portion 131. The uncoated portion 131 may be bonded (for example, laser welded) to the current collector plate 132 while at least partially folded. The battery cell 100 may not include an electrode tab connecting the uncoated portion 131 of the electrode assembly 130 and the current collector plate 132. Since the battery cell 100 in the present disclosure is formed in a tab-less form, the internal resistance of the battery cell 100 may be reduced.

The battery cell 100 may include a terminal portion 170 (for example, the terminal portion 120 of FIG. 1) . The terminal portion 170 may be mounted to the case 110. In an embodiment, the terminal portion 170 may be a rivet terminal. The terminal portion 170 may be in contact with the current collector plate 132 and may be coupled to the lower plate 111. The terminal portion 170 may be coupled to the lower plate 111 of the case 110 by riveting. The terminal portion 170 may be inserted into the through hole 113 of the case 110. The terminal portion 170 may be welded to the current collector plate 132 connected to the electrode assembly 130. The terminal portion 170 may be electrically connected to the exterior of the battery cell 100.

The current collector plate 132 may electrically connect the electrode assembly 130 and the terminal portion 170. For example, the current collector plate 132 may contact (for example, weld) the uncoated portion 131 of the electrode assembly 130 and the terminal portion 170. At least a portion of the current collector plate 132 may be positioned between the uncoated portion 131 of the electrode assembly 130 and the terminal portion 170. The current collector plate 132 may be made of a conductive material.

The battery cell 100 may include an insulator 140. The insulator 140 may prevent unintended electrical contact between components of the battery cell 100. For example, the insulator 140 may prevent contact between the current collector plate 132 and the case 110. The insulator 140 may surround at least a portion of the terminal portion 170. At least a portion of the insulator 140 may be positioned between the case 110 (for example, the lower plate 111) and the electrode assembly 130. The insulator 140 may be made of an insulating material.

The battery cell 100 may include a gasket 180. The gasket 180 may seal the gap between the case 110 and the terminal portion 170. The gasket 180 may have a substantially closed curved shape. By the gasket 180, leakage of electrolyte inside the battery cell 100 may be prevented. By the gasket 180, inflow of foreign substances outside the battery cell 100 may be prevented.

A method (200) of manufacturing a battery cell may include a case preparation process (210), an insulator arrangement process (220), an electrode assembly arrangement process (230), and an electrolyte injection process (240). A battery cell 100 may be manufactured using the method (200) of manufacturing a battery cell.

The case preparation process (210) may be a process of preparing a case 110 including a lower plate 111. The case 110 may include a lower plate 111 and a wall portion 112 extending from the lower plate 111.

The battery cell 100 may include a first adhesive member 150. The first adhesive member 150 may be disposed between the insulator 140 and the lower plate 111 of the case 110.

The insulator arrangement process (220) may be a process of disposing the insulator 140 to the lower plate 111 of the case 110 using the first adhesive member 150. In the insulator arrangement process (220), the insulator 140 may be disposed on the upper surface 111a of the lower plate 111.

In an embodiment, the first adhesive member 150 may cover at least a portion of the lower plate 111. For example, the first adhesive member 150 may cover 60% or more of the upper surface 111a of the lower plate 111. By covering 60% or more of the upper surface 111a with the first adhesive member 150, a bonding force between the insulator 140 and the case 110 may be secured.

In an embodiment, the first adhesive member 150 may be provided on the case 110. For example, the first adhesive member 150 may be applied to the lower plate 111. The method (200) of manufacturing a battery cell may further include a first adhesive member disposing process of applying the first adhesive member 150 to the lower plate 111.

In an embodiment, the first adhesive member 150 may be provided on the insulator 140. For example, the first adhesive member 150 may be in contact with the case 110 while being adhered to the insulator 140. The first adhesive member 150 may include an adhesive material. The first adhesive member 150 may be an adhesive tape, an adhesive, or a coating agent. The type of adhesive member may be selected depending on process characteristics, and the coating agent or adhesive may be applied through a nozzle. If automated processes are not feasible, the process may be simplified and applied by attaching adhesive tape to the insulator or current collector plate.

The first adhesive member 150 may improve the assembly precision of the battery cell 100. For example, the first adhesive member 150 may secure the position of the insulator 140 relative to the case 110. In an embodiment, the first adhesive member 150 may connect the electrode assembly 130 and the insulator 140 before electrolyte injection. Damage to components of the battery cell 100 during transport may be prevented by the first adhesive member 150.

The electrode assembly arrangement process (230) may be a process of disposing the electrode assembly 130 on the insulator 140. In the electrode assembly arrangement process (230), the electrode assembly 130 may be disposed within the case 110 while in contact with the current collector plate 132. For example, in the electrode assembly arrangement process (230), the electrode assembly 130 may be moved in the first direction (−Z direction).

The electrolyte injection process (240) may be a process of injecting an electrolyte (EL) into the case 110. For example, the electrolyte (EL) may be injected into the battery cell 100 through an electrolyte inlet (not illustrated).

The adhesive member (for example, the first adhesive member 150 and/or the second adhesive member 160) may be melted (for example, decomposed) by the electrolyte (EL). For example, the adhesive members 150 and 160 may include at least one of polyethylene terephthalate, epoxy, polyethylene, polyimide, polyvinyl chloride, polyacrylonitrile, or polycarbonate. For example, the adhesive member may include a porous copolymer polyimide or polyacrylonitrile having insulating properties and excellent thermal stability to prevent internal shorts that may occur during the process and to prevent the insulator from being damaged by heat generated during the welding joint of the terminal and the current collector plate. In addition, in the case in which the adhesive member that receives surface pressure during the process requires elasticity or flexibility, polyethylene or polyvinyl chloride may be additionally included. In an embodiment, a carbonate-based solvent of the electrolyte (EL) may penetrate between the polymers of the first adhesive member 150, thereby melting at least a portion of the first adhesive member 150. By decomposing the adhesive members 150 and 160, the impact of the adhesive members 150 and 160 on the finished product of the battery cell 100 may be prevented.

In an embodiment (for example, in FIG. 4), the battery cell 100 may include a second adhesive member 160. For example, the second adhesive member 160 may be disposed between the insulator 140 and the electrode assembly 130. The electrode assembly arrangement process (230) may attach the electrode assembly 130 to the insulator 140 using the second adhesive member 160. At least portion of the descriptions regarding the first adhesive member 150 may be applied to the second adhesive member 160.

In an embodiment, a second adhesive member 160 may be provided on the insulator 140. For example, the second adhesive member 160 may come into contact with the electrode assembly 130 while being bonded to the insulator 140. The second adhesive member 160 may be disposed within the case 110 during the insulator arrangement process (220). At least a portion of the insulator 140 may be positioned between the first adhesive member 150 and the second adhesive member 160.

The assembly precision of the battery cell 100 may be improved by the second adhesive member 160. For example, the second adhesive member 160 may secure the position of the electrode assembly 130 relative to the insulator 140. In an embodiment, the second adhesive member 150 may connect the electrode assembly 130 and the insulator 140 before electrolyte injection.

The battery cell 100 may optionally include a second adhesive member 160. For example, the second adhesive member 160 may enhance the bonding strength between the insulator 140 and the electrode assembly 130. In an embodiment, the battery cell 100 may include an electrode assembly 130 having a diameter (for example, 40 mm) greater than or equal to a specified size. As the size of the electrode assembly 130 increases, positional control of the electrode assembly 130 relative to the insulator 140 may be required. In the battery cell 100, the electrode assembly 130 having a diameter greater than or equal to a specified size may be attached to the insulator 140, using the second adhesive member 160.

The adhesive members (for example, the first adhesive member 150 and/or the second adhesive member 160) may be melted by the electrolyte (EL) and mixed with the electrolyte (EL) after the insulator 140 is secured to the lower plate 111.

By melting the adhesive members 150 and 160 by the electrolyte (EL), a chemical reaction between the adhesive members 150 and 160 and the electrolyte (EL) may be prevented. By preventing the chemical reaction between the adhesive members 150 and 160 and the electrolyte (EL), current flow in the battery cell 100 may be prevented from being interrupted and performance degradation of the battery cell 100 may be prevented.

The adhesive members 150 and 160 melted by the electrolyte (EL) may be identified using electrolyte composition analysis. For example, the composition of the electrolyte (EL) may be analyzed using Fourier transform-infrared (FT-IR) spectroscopy or a gas chromatography-mass spectrometry device (GS-MSD). The composition of the electrolyte (EL) containing the molten adhesive members 150 and 160 may differ from the composition of the electrolyte of a battery cell 100 that does not use the adhesive members 150 and 160 during the manufacturing process.

The above description is merely an example of applying the principles of the present disclosure, and other configurations may be further included without departing from the scope of the present disclosure.

As set forth above, according to an embodiment, the manufacturing cost of a battery module may be reduced.

According to an embodiment, the manufacturing process of a battery module may be simplified.

Only specific examples of implementations of certain embodiments are described. Variations, improvements and enhancements of the disclosed embodiments and other embodiments may be made based on the disclosure of this patent document. For example, the present disclosure may be implemented by deleting some of the components in the above-described embodiments, and the embodiments may be implemented in combination with each other.

What is claimed is:

1. A method of manufacturing a battery cell, comprising:
preparing a case including a lower plate;
disposing an insulator on the lower plate of the case using a first adhesive member;
disposing an electrode assembly on the insulator; and
injecting an electrolyte into the case,
wherein the adhesive member is configured to be melted by the electrolyte.

2. The method of claim 1, wherein the first adhesive member comprises at least one of polyethylene terephthalate, epoxy, polyethylene, polyimide, polyvinyl chloride, polyacrylonitrile, or polycarbonate.

3. The method of claim 1, further comprising disposing the first adhesive member by applying the first adhesive member to the lower plate.

4. The method of claim 1, wherein the first adhesive member is in contact with the case while being adhered to the insulator.

5. The method of claim 1, wherein the first adhesive member is an adhesive tape, an adhesive, or a coating agent.

6. The method of claim 1, wherein the disposing the electrode assembly is performed by attaching the electrode assembly to the insulator using a second adhesive member,
wherein the second adhesive member is configured to be melted by the electrolyte.

7. The method of claim 6, wherein the second adhesive member is in contact with the electrode assembly while being adhered to the insulator.

8. A battery cell comprising:
an electrode assembly;
a case including a lower plate supporting the electrode assembly;
an insulator at least partially positioned between the electrode assembly and the lower plate; and
an adhesive member melted by an electrolyte and mixed with the electrolyte after the insulator is secured to the lower plate.

9. The battery cell of claim 8, wherein the adhesive member comprises at least one of polyethylene terephthalate, epoxy, polyethylene, polyimide, polyvinyl chloride, polyacrylonitrile, or polycarbonate.

10. The battery cell of claim 8, further comprising:
a current collector plate bonded to an uncoated portion of the electrode assembly; and
a terminal portion in contact with the current collector plate and coupled to the lower plate.
